(19) United States
(12) Patent Application Publication
(10) Pub. No.: US 2007/0056983 A1
(43) Pub. Date: Mar. 15, 2007

(54) INTELLIGENT FLUID DISTRIBUTION SYSTEMS AND METHODS

(75) Inventor: Bruce J. Wells, Centennial, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Thermatech Systems, Inc., Centennial, CO (US)

(21) Appl. No.: 11/470,961

(22) Filed: Sep. 7, 2006

Related U.S. Application Data
(63) Continuation-in-part of application No. 10/784,052, filed on Feb. 19, 2004.
(60) Provisional application No. 60/714,991, filed on Sep. 7, 2005.

(51) Int. Cl. G01F 11/00; B67B 7/00

(52) U.S. Cl. 222/1

(57) ABSTRACT

Various embodiments of the invention provide devices, systems and methods to provide and/or facilitate the distribution and/or dispensing of fluids, including without limitation industrial fluids. In some embodiments, an intelligent handle and/or a fluid management device may be provided. In an aspect of the invention, the intelligent handle and/or the fluid management device may be integrated with, and/or configured to be used with, conventional fluid storage and/or distribution systems, such as drums, tanks, hose reel systems and/or the like. In another aspect of the invention, the intelligent handle and/or the fluid management device may be integrated with, and/or configured to be used with, specialized fluid storage and/or distribution systems, such as tanks and/or drums adapted for use with a fluid management device and/or an intelligent handle.

### CROSS-REFERENCE TO RELATED APPLICATIONS

This application is a nonprovisional claiming the benefit of provisional U.S. Patent Application No. 60/714,991, entitled “Intelligent Fluid Distribution Systems and Methods,” filed Sep. 7, 2005 by Bruce J. Wells, the entire disclosure of which is incorporated herein by reference.

This application is also a continuation-in-part of U.S. patent application Ser. No. 10/784,052, entitled “Systems and Methods of Fluid Distribution” and filed Feb. 19, 2004 by Bruce J. Wells (the “'052 application”), the entire disclosure of which is incorporated herein by reference.

### FIELD OF THE INVENTION

The present application relates generally to the distribution of fluids, and specifically to methods and systems for distributing such fluids.

### BACKGROUND OF THE INVENTION

There are many uses of industrial fluids. For example, manufacturing industries often use industrial fluids to lubricate manufacturing equipment, as coolant in cutting operation, and the like. Similarly, in the automotive industry, vehicle service centers use a variety of fluids in the repair and/or maintenance of vehicles.

Generally if a user consumes such fluids in any substantial quantity, the user prefers to receive the fluids in bulk form, in order to realize cost savings in supply and delivery costs, reduce container waste, and the like. Merely by way of example, an automotive repair shop might maintain an underground (or aboveground) bulk storage tank for motor oil, and might contract with an oil supplier for delivery of bulk oil to that tank on a periodic or as-needed basis.

The receipt of fluids in bulk, however, presents several problems, for both the fluid supplier and the user of those fluids. For example, the installation and/or maintenance of facilities for storing and/or dispensing bulk fluids generally are relatively expensive, requiring a substantial outlay of initial capital to install the facilities as well as period costs to maintain the facilities. Further, the user generally must purchase the fluid at the time of delivery (perhaps on some terms, such as net 30), even though most of the fluid may not be used for some time, tying up additional capital that could be better used in other ways. In addition, fluid stored in bulk tanks requires specialized equipment to transfer a usable quantity of the fluid from the bulk tank to the location in which is the fluid is to be used. For example, many users of bulk fluids use hoses incorporated within hose reels, such as those available from Samoa Industrial, S.A. of Gijon, Spain, to deliver fluids from bulk tanks to the location of use. Such reel systems, however, are often expensive, and they do not allow the use of fluids in locations outside the reach of the hoses. Moreover, such hose reels require bulk tank systems, including pumps, pipes and reels (as well as labor costs associated with installing such equipment), and therefore normally are used only for fluids consumed in relatively high volumes—other fluids are generally purchased in individualized containers, imposing higher per-unit costs on the supplier and/or user. Additionally, such installed systems are normally considered, for tax purposes, appurtenances to the property on which they are installed, requiring lengthy amortization and other unfavorable tax treatment. Those skilled in the art will appreciate that such classification of these systems also hinders the fluid supplier's ability to lease (or provide other favorable terms towards the user's acquisition of) the systems.

Alternatively, a user may pump a limited quantity of a fluid from a bulk tank into a portable cart, which the user then transports to the use location. Examples of such carts are also available from Samoa Industrial.

The '052 application describes systems that provide many advances over prior fluid distribution systems, including the ability to track and account for fluids dispensed, as well as additional advanced functionality. Embodiments of the present invention can provide fluid management features similar to those described in the '052 application, and in some cases can be used to provide such functionality when used with existing distribution systems, such as those described above.

### BRIEF SUMMARY OF THE INVENTION

Various embodiments of the invention, then, provide devices, systems and methods to provide and/or facilitate the dispensing of fluids, including without limitation industrial fluids, as well as systems, methods and software to allow the dispensing of fluids to be tracked and/or accounted for. In some embodiments, an intelligent handle and/or a fluid management device may be provided. In an aspect of the invention, the intelligent handle and/or the fluid management device may be integrated with, and/or configured to be used with, conventional fluid storage and/or distribution systems, such as drums, tanks, hose reel systems and/or the like. In another aspect of the invention, the intelligent handle and/or the fluid management device may be integrated with, and/or configured to be used with, specialized fluid storage and/or distribution systems, such as tanks and/or drums adapted for use with a fluid management device and/or an intelligent handle. In a particular set of embodiments, a fluid management device and/or an intelligent handle may be used with a fluid distribution system similar to those described in the '052 application.

The following detailed description together with the accompanying drawings will provide a better understanding of the nature and advantages of the present invention.

### BRIEF DESCRIPTION OF THE DRAWINGS

FIG. 1A is a plan view of an intelligent handle in accordance with various embodiments of the invention.

FIG. 1B is a side elevation of an intelligent handle in accordance with various embodiments of the invention.

FIGS. 2A and 2B are perspective drawings of a fluid management device in accordance with various embodiments of the invention.

### DETAILED DESCRIPTION OF THE INVENTION

The fluid distribution systems described in the '052 application advantageously provide, inter alia, improved mobility, precise filling, and/or a record-keeping system (with wireless data transmission, in some cases). In some cases, however, a fluid user or distributor may wish, instead of implementing such a system, to obtain some or all of the advantages of such systems without having to replace existing systems and/or without incurring the cost of such advance systems. Embodiments of the invention, then, provide devices, including without limitation intelligent handles and fluid management devices, that can provide many such benefits, and which may (in some cases) be implemented within existing fluid dispensing systems. Embodiments of the invention, can add to existing (or new) systems features such as access control/accountability, precise dispensing and record-keeping that may be incorporated into an existing delivery “systems,” such as a fluid cart, drum, etc. without data recording and/or transmission capabilities.

Merely by way of example, a set of embodiments provides an “intelligent handle,” which may be used to dispense fluids from any suitable fluid storage and/or distribution device or system (such as a drum, tank, cart, etc.) in a manner similar to conventional dispensing handles. The intelligent handle, however, can provide fluid tracking and accounting functionality, as well, in some cases, as access control, prevention of cross-contamination, record-keeping, and/or tracking a fluid history for various machines. In some aspects, then, the intelligent handle may be adapted to be used in place of (and/or as a supplement to) conventional dispensing handles. Hence, for example, an intelligent handle may have a coupling mechanism similar to those of conventional handles, such that it can be coupled to hoses, tanks, etc. in a manner similar to conventional handles.

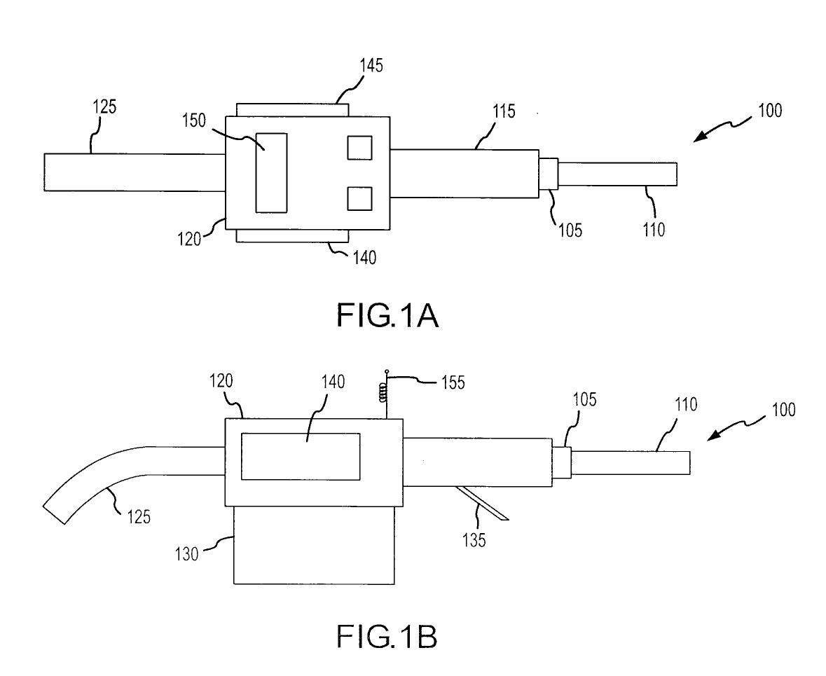

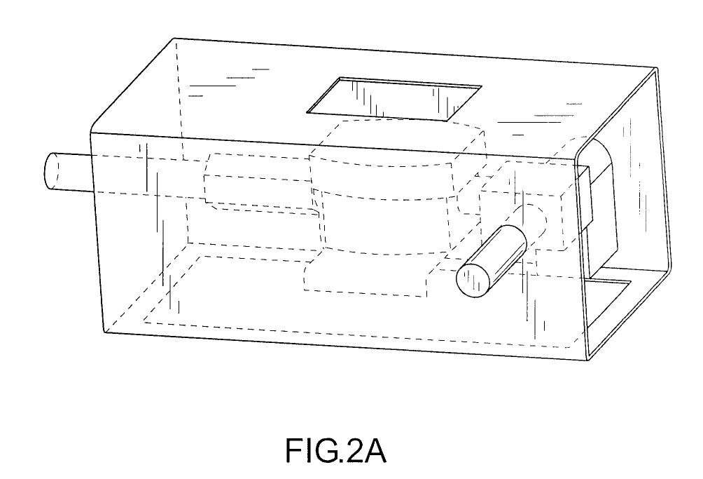

FIGS. 1A and 1B illustrate an intelligent handle 100 in accordance with some embodiments of the invention. The intelligent handle 100 may comprise a coupling device 105, which can allow the intelligent handle 100 to be coupled to a hose 110 (perhaps in a conventional manner), which may then provide fluid communication with a fluid source (such as a tank, hose reel, drum, etc.) in a known manner.

The intelligent handle 100 may also comprise a handle portion 115, a body portion 120 and/or a spout 125. The intelligent handle 100 further comprises, in some embodiments, a metering device 130, which can be used to measure and/or control the amount of fluid dispensed by the intelligent handle 100. The metering device 130 can be any type of device capable of measuring and/or controlling the amount of fluid dispensed, including without limitation the metering devices described in the '052 application. In some cases, the intelligent handle 100 can include a flow control device 135 (such as a trigger, etc.) that can be used to modulate fluid flow (subject, perhaps, to the control of the metering device 130).

In a set of embodiments, the intelligent handle 100 may also include a processor and/or a storage medium (not shown on FIGS. 1A and 1B). The storage medium might comprise instructions executable by the processor to perform functions described herein and/or to store data required by the functions described herein. Other electronics may be provided as well. Merely by way of example, some embodiments include an access card reader 140 (which might be a bar code reader, a proximity scanner, a magnetic stripe reader, etc.), which can be configured to read a user's access card, as described in further detail below. Other embodiments may include a remote communication device 145 (such as an radio frequency identification (“RFID”) scanner and/or writer, a Bluetooth transmitter, etc.), which can provide relatively short-range communication with identification tags, cards, etc. as described in further detail below. In further embodiments, the intelligent handle 100 may comprise a display device 150, such as an LCD screen, etc. that can be used to display information for a user of the intelligent handle 100 and/or another. The access card reader 140, remote communication device 145 and/or display device 150 each may be in communication with the processor.

In some cases, the intelligent handle 100 includes a network communications system 155, which can include any necessary hardware and/or software for providing network communications. This system 155 might include, for example, wired and/or wireless communication facilities capable of communicating via a network, such as the networks described in the '052 application. Examples of such communication facilities are described in further detail in the '052 application. In other embodiments, however, the intelligent handle 100 may not need a network communication system. Merely by way of example, as described below, the intelligent handle 100 might not communicate with a server, but identification tags (such as RFID tags, etc.) might provide communication with the server.

In operation, some embodiments of the intelligent handle 100, may operate similarly to a conventional dispensing handle. That is, when a user activates the flow control device 135, the fluid to be dispensed will flow from the fluid source, through the hose 110, coupling device 105 and/or handle 115, into the body portion 120, and out through the spout 125 to the intended application of the fluid. Various embodiments, however, can improve upon this process. Merely by way of example, the metering device 130 may be used, as noted above, to measure and/or to control the flow of the fluid being dispensed. As another example, the intelligent handle may incorporate electronics, for instance, those described above, that can allow for enhanced functionality.

For instance, in accordance with a set of embodiments, the intelligent handle 100 may be used in the following manner: A user begins by swiping an access card over the card reader 140 on the handle. In some embodiments, the card reader may be an electronic read/write unit, which might identify the user based on the access card. (In some cases, the access card, or any other type of identification, might be compatible with the remote communication device 145—e.g., if the remote communication device 145 is an RFID scanner, the access card might incorporate an RFID chip—such that the remote communication device 145 might incorporate the functionality of the access card reader 140, which might be omitted. By the same token, in some embodiments, the access card reader 140 might be configured to perform the functions of the remote communication device 145, such that the remote communication device 145 can be omitted). In some cases, the processor, storage medium, and/or remote communication device 145 (and/or access card reader 140) may be incorporated into a single device (such as an integrated RFID scanner, for example).

The access card reader 140, after identifying the user, might communicate to the processor an identification of the user. (Alternatively, the processor might be configured, via software, etc., to identify the user, based on data received from the access card reader 140). Upon identifying the user, the processor activates the handle recording system and LCD 150 screen. (In some cases, to prevent unauthorized use, the system would refuse to activate the LCD screen and/or activate a sound device until an authorized user has been identified. The storage medium might comprise a database of authorized users.) In some cases, then, after an access card has been identified by the reader 140, the intelligent handle 100 will activate a flashing light (LED) on the intelligent handle 100, indicating a dispensing operation in progress.

In a set of embodiments, the handle may be preprogrammed with one or more identifiers indicating the delivery system it is attached to (hose reel number, cart number etc) and/or the fluid type being dispensed. The user then moves the handle 100 to the dispensing point (receiver) which could be a vehicle, machine etc. In a particular set of embodiments, the dispensing point will have associated therewith an information storage device (which may be an RFID chip, etc.) that is capable of receiving information from the intelligent handle 100 (e.g., via the remote communication device 145). Merely by way of example, in the automotive context, each auto that is to be serviced may be assigned an information storage device. The device might be relatively permanently affixed to the auto (e.g., as part of a sticker on a windshield, etc.) and/or merely temporarily associated with the auto (e.g., affixed to a plastic card that is placed on the dashboard of the auto during servicing, etc. Similar procedures may be used in other environments. For example, in a manufacturing environment, a storage device may be affixed to each machine that requires fluids (lubricants, etc.).

The user then operates the flow control device 135 on the intelligent handle 100, thereby dispensing the fluid. As the fluid is dispensed, the metering device 130 may measure the amount of fluid dispensed and/or stop the dispensing operation after the desired amount has been dispensed. (Hence, in some embodiments, the intelligent handle 100 may comprise an input device, such as a keypad, etc., which can allow the user to indicate the amount of fluid that should be dispensed. This keypad could also be used to provide an identification number of the user, e.g., in lieu of using an access card.)

When dispensing has been completed (as indicated by the metering device restricting further dispensing, a period of inactivity, manual indication by the user, etc.), the metering device 130 may then indicate to the processor how much fluid was dispensed. The processor may record the dispensed volume data and/or correlate that data with the previously recorded user information and fluid identifier. The user then moves the handle 100 (and/or in particular, the remote communication device 145) within sufficient proximity to the storage device associated with the dispensing point to allow communication between the handle 100 and the storage device. Upon sensing the presence of the storage device, the handle 100 (and/or components thereof, such as the remote communication device 145 and/or processor) downloads the data from the handle onto the storage device, thereby completing the dispensing process. Such data can include, inter alia, the time/date of the dispensing operation, the user performing the operation (who might be identified as noted above), the type of fluid dispensed, the amount of fluid dispensed, and/or any other pertinent information.

As a variant of this system, the storage device for a particular dispensing point might contains information on the fluid to be used with a particular machine, auto, etc. and therefore could be scanned first by the handle, as a required step. If the wrong fluid is being applied to the fill point, the handle 100 could warn of an incorrect fluid by means of an audible sound, a flashing light, etc. and/or could disable dispensing.

In the case of a fixed target of the fluids such as a machine, the tag could be placed near the fill point where it could easily be accessed during a topping off procedure. The data from this and previous dispenses could then be downloaded from the tag to a handheld computer or delivered by wireless transmission to a central computer (which might be the server discussed in the '052 application). This might be done as a regular maintenance interval. The data could be set up in a directory such that the data could be sorted by machine, thus producing a maintenance history and tracking system for each machine. Further, any of the functions ascribed to the server in the '052 application could be performed as well.

As another example, in the case of a vehicle, the process could begin, as in a vehicle servicing situation, with the service writer who takes the customer data and service details as the vehicle is brought into the facility. The service writer's computer terminal (which may be in communication with a server, such as the server described in the '052 application) may be equipped with a read/write pad connected to a serial port on the terminal. As part of the write up procedure, a blank RFID tag is swiped over the pad, thereby downloading the customer data onto the tag. (Other storage devices, such as magnetic stripe cards, etc., with appropriate download procedures, may be used as well.) The tag is then placed on the vehicle, perhaps under a windshield wiper or similar so that it is with the car during fluid servicing. Upon completion of fluid service, the vehicle is typically driven out of the facility and the paperwork delivered to a cashier or parts manager. This may be a paperless process where the records are only on the terminals of the service technician or manager. The RFID tag is removed from the vehicle and delivered to the parts manager where it is swiped over a read/write pad connected to his terminal. This downloads the dispensed fluid data along with the associated customer data.

The RFID tag (or other storage device) provides the means of getting the data to the point where records are typically managed in such facilities. It has the advantage of requiring neither wired or wireless systems for data transfer, but rather uses the vehicle itself as part of the customary movement process to get the data to the record-keeping location. The download data may also be used to adjust inventory records in the manager's computer records and thus keep an accurate record of fluid inventory levels in the storage tanks. Further, the system may be set up so that on a periodic basis the dispensed volume data may be transmitted (e.g., electronically) to the supplier of fluids to the customer (e.g., as described in the '052 application). This would provide a way for the supplier to more accurately plan deliveries to customers, thus avoiding the problem of depleted tanks or less than efficient delivery schedules. This also allows the fluid supplier to bill (and, perhaps, get paid) on an as-pumped basis, and allows the fluid user to avoid a sizeable upfront payment for fluids that might not be used for some time.

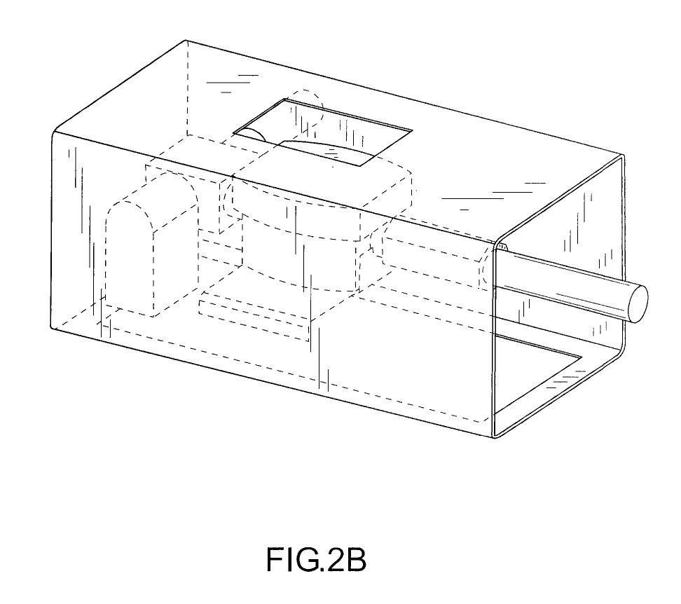

Another set of embodiments provides a fluid management device. An exemplary fluid management device 200 is depicted by FIGS. 2A and 2B. The fluid management device 200 can be used, inter alia, in applications where fluids are dispensed from a central area without access control, accountability, and/or record-keeping. For example, many plants fill containers from stationary drums or tanks and the operator carries the fluids to the application. The fluid management device 200 provides a means of tracking dispensing of this type.

For example, in certain embodiments, there may be one or more fluid sources, such as tanks, drums, etc. Each fluid source generally will be equipped with a pump device, which directs fluid through the fluid management device 200, which may be mounted on the tank, drum, etc. The fluid management device 200 may be in communication with a keypad, which can be mounted on a wall or in another convenient location.

The functions and operation of the fluid management device 200 are similar, in some aspects, to those of the intelligent handle, described above. For example, in a dispensing operation involving the fluid management device 200, a user begins by swiping an access card over a wall-mounted keypad, which may comprise some or all of the electronics described with respect to the intelligent handle described above. This activates a display and queries the operator for fluid type, volume, machine number etc. similar to the process described in the '052 application.

The wall-mounted keypad, in some embodiments, is equipped with a communication system (which may be similar to the systems described above and/or in the '052 application), which can provide wired and/or wireless communication with a server computer. The computer determines the remaining volume of the requested fluid, and if adequate, authorizes the dispense. The system activates the pump for that tank and the operator dispenses the fluid via a trigger-operated handle. It may be a pre-set volume or a free volume dispense. The volume dispensed is recorded and transmitted to the central computer as described in the '052 application. The central computer, in addition to possibly transmitting data about pumped fluids to a fluid supplier, also can allow for inventory tracking by the user and/or supplier of the fluids.

In a set of embodiments, a fluid management device and/or an intelligent handle can be used to support business processes associated with the dispensing of fluid. Merely by way of example, the '052 application discloses how a user of fluid may be billed for fluid on an as-used basis, (e.g., instead of upon delivery to the user's location). Embodiments of the present invention can allow for similar billing arrangements. Further embodiments of the invention can allow an intelligent handle and/or fluid management device (along with, in some cases, associated hardware and/or software) to be billed to a fluid user as an added service along with the fluid itself.

For instance, in a set of embodiments, if the fluid user is billed a particular amount per gallon of fluid dispensed, a surcharge (which may be a one time charge, calculated on a periodic basis, calculated relative to the amount of fluid dispensed, etc.) may be added to the price of the dispensed fluid and/or may be amortized over the length of the fluid contract. Merely by way of example, a fluid supplier may provide the intelligent handle, fluid management device, etc. free of initial charge (or at some initial charge reduced from the value of the equipment) and then charge a monthly fee for the use of the equipment, in addition to the fees for the fluid dispensed. As another example, the fluid supplier might add a per-gallon (or any other appropriate measurement) surcharge to the cost of the fluid to account for use of the equipment. In some cases, the fees charged for the use of the equipment may decrease as the amount of fluid dispensed increases, for example to incent a user to dispense more relatively more fluid with the equipment.

To illustrate certain features of some embodiments, consider the following example: A vehicle service station contracts with a fluid supplier for oil and other automotive fluids. As part of the contract, the fluid supplier delivers (and perhaps installs) one or more intelligent handles and/or fluid management devices to retrofit an existing hose reel system at the service station. The fluid supplier may also provide a number of RFID cards (which might, for example, be credit-card sized plastic cards to which an RFID chip is embedded or implanted); alternatively, the service station might purchase these separately. Employee ID cards with some type of identification device (such as those described above, for instance) may also be provided to employees of the service station.

When a vehicle enters the station for servicing, an RFID card may be encoded (e.g. via an RFID writer at a central computer, service terminal, etc.) with pertinent information about the vehicle (which might include an identification of the vehicle, such as VIN, license plate number, etc., as well as, in some cases, service history, type of service desired, recommended fluid products, etc.). The RFID card then is placed on the dash of the vehicle (or in some other convenient location). (Alternatively, an RFID chip may be temporarily or permanently affixed to a vehicle windshield, door, etc.).

When service is to begin, a service station operator may use his ID card to activate the intelligent handle and/or fluid management device, and optionally inputs the type of fluid and/or the amount of fluid to be dispensed. Optionally, a the handle/fluid management device may interrogate the RFID chip to ensure that the selected fluid (and/or the amount of fluid) are consistent with the service to be performed, manufacturer recommendations, service history, etc. If an inconsistency is noted, the handle/fluid management device optionally may warn the operator and/or disable itself until an appropriate fluid/amount is selected. The operator then may dispense the fluid.

When the dispensing operation has been completed (perhaps by the intelligent handle/fluid measurement device disabling the operation after the appropriate amount of fluid has been dispensed), the intelligent handle/fluid management device writes to the RFID card the amount and/or type of fluid dispensed, along with any other desired information (date and time of dispensing, operator identification, etc.). This may be performed for a plurality of dispensing operations (e.g., oil, transmission fluid, etc.), depending on the type of vehicle service.

When the service has been completed, data from the RFID chip can be downloaded (e.g., via an RFID reader at a service terminal and/or central computer). Software at the computer then may be configured to prepare an itemized invoice for the vehicle owner. The software may be further configured to record the amount and type(s) of fluid dispensed, and an inventory database may be debited in the appropriate amount, and/or any other accounting for the fluid may be performed.

At the end of a given period (e.g., a day, a month, etc.), and/or per transaction, on demand, when fluid inventory runs low, etc., the service station's computer may be configured to upload data about fluids dispensed to the supplier's computer. The service station then may be billed for the fluids (perhaps with a surcharge and/or a separate fee for the equipment), and/or the supplier may be notified that additional fluid supplies are needed, based for example on inventory levels.

As noted above, certain embodiments of the invention advantageously can be used to retrofit existing fluid dispensing systems, and various other embodiments need not be installed permanently. These features can allow a fluid supplier to provide intelligent handles, fluid management devices and/or associated equipment without requiring the significant initial capital investment required of some traditional systems. While certain embodiments are described above with respect to the dispensing of industrial and other fluids, those skilled in the art will appreciate that similar methods and/or systems may be applied to the distribution and/or dispensing of any type of material that can be metered, allowing incremental payment, automated accounting, and other advantages of various embodiments to be applied across a wide variety of distribution channels.

As another example, a fluid management device (such as the device described above) can be used in conjunction with an eductor system, in which a concentrated fluid (such as a lubricant, pesticide, and/or the like) is added to a stream of another fluid (such as water and/or another solvent). The fluid management device, for example, (and/or a component thereof, such as a metering device) can be disposed between the holding tank for the concentrated fluid and the source of the other fluid, such that, as the concentrated fluid is drawn into the stream, the fluid management device can track usage of the concentrated fluid, in a manner similar to that described above.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

What is claimed is:

1. A system for facilitating the dispensing of fluids, the system comprising:
a metering device configured to measure an amount of fluid dispensed; and
a communication device configured to transmit information about the amount of fluid dispensed for reception by a storage device specific to a target of the fluid.

2. A method of dispensing a fluid, the method comprising:
dispensing an amount of a fluid to a target;
measuring the amount of fluid dispensed; and
electronically communicating information about the amount of fluid dispensed to a storage device specific to a the target.

3. A method of accounting for a dispensed fluid, the method comprising:
dispensing an amount of a fluid to a target;
recording information about the dispensed amount of fluid to a storage medium associated with the target of the dispensed fluid;
transmitting from the storage medium to a computer the information about the dispensed fluid; and
taking an action at the computer with respect to the dispensed fluid.

4. A method of providing fluid dispensing equipment, the method comprising:
providing to a fluid user a set of fluid dispensing equipment;
providing to the fluid user a fluid to be dispensed with the dispensing equipment; and
billing the fluid user an incremental amount for the use of the dispensing equipment.
